(19) United States
(12) Patent Application Publication
(10) Pub. No.: US 2013/0318561 A1
(43) Pub. Date: Nov. 28, 2013

(54) NETWORK SYSTEM, HOME GATEWAY, CONTENT PLAYBACK METHOD AND RECORDING MEDIA FOR RECORDING A NETWORK MANAGEMENT PROGRAM

(71) Applicant: Koji Fujiwara, Shizuoka (JP)

(72) Inventor: Koji Fujiwara, Shizuoka (JP)

(73) Assignee: NEC ACCESS TECHNICA, LTD., Shizuoka (JP)

(21) Appl. No.: 13/983,872

(22) PCT Filed: Jan. 20, 2012
(86) PCT No.: PCT/JP2012/051732

§ 371 Date: Aug. 6, 2013

(30) Foreign Application Priority Data
Feb. 8, 2011 (JP) 2011-025244

(51) Int. Cl. H04N 21/436; H04N 21/214

(52) U.S. Cl. CPC H04N 21/43615; H04N 21/2143
USPC 725/82

(57) ABSTRACT

To cause a service provider to specify playback content and playback order from an outside of a home network and cause the service provider to play back the playback content in the home network.

The present invention comprises: a playback list receiving means for downloading in advance and installing an OSGi bundle for remotely managing a home gateway from an external server, and receiving playback list data which can be used for specifying a list of playback content and the playback order of content is received from an external server; a playback content determination means that determines, on the basis of the playback list data, the playback content and the playback order of the content; and a playback instruction means for causing a device connecting to the home network to playback the playback content in accordance with the playback order determined by the playback content determination means, when a playback instruction for the content is received from the external server in accordance with the OSGi bundle.

### TECHNICAL FIELD

The invention relates to a network system, a home gateway, content playback method, and a recording medium for recording a network management program which cause a device connected to a home network to play back content in a system having an external server that can access the home network via an external network.

### BACKGROUND ART

Content is played back in a home network using functions established in DLNA (Digital Living Network Alliance). In this case, first, playback content is selected from content stored in a content server (DMS: Digital Media Server) in the home network. And the content is transferred to a content display device (DMR: Digital Media Renderer) by a content playback device (DMP: Digital Media Player) and a content control device (DMC: Digital Media Controller) and the content is played back.

And, a related technology by which content is played back in a home network is described in Patent document 1. In the related technology described in Patent document 1, when a request is sent from a WebTV placed in an internal network (home network), a home gateway receives a content list from a content list providing server placed in an external network. And the content is received from a content server in accordance with the content list and is provided to the WebTV.

And, as a related technology related to the home network, Patent documents 2 and 3 describe, for example, a technology in which a home gateway of a home network is remotely managed from an external server in an external network. Patent documents 2 and 3 describe that a program called OSGi bundle for remotely managing the home gateway is installed in a client device and the home gateway to carry out communication with the client device and the home gateway and to carry out specific processes.

### PRIOR ART DOCUMENTS

### Patent Document

Patent document 1 JP2009-230256 (paragraphs 0024 to 0027, and paragraphs 0068 to 0070)

Patent document 2 JP2010-7590 (paragraphs 0010 to 0011, paragraphs 0015 to 0016, and paragraph 0019)

Patent document 3 JP2009-500898 (paragraphs 0018, 0029, 0032 and 0042)

### SUMMARY OF THE INVENTION

### Problem to be Solved by the Invention

However, in the related technology described in Patent document 1 and the like, content is played back in response to the request from the home network, and only end-user-generated content can be played back. Hence, the related technology cannot be applied in the case where a content playback is intended to be carried out in the home network in accordance with an instruction from the external server outside the home network, and it is not possible for a service provider to send the content from the external server into the home network by using the function of DLNA in the home network. And if a device in the home network is caused to playback the content in accordance with the instructions from the outside of the home network by directly using the related technology described in Patent document 1 and the like, it is necessary to newly develop a special device and a special system and it is therefore costly.

And if the related technologies described in Patent documents 2 and 3 are used, it is possible to remotely manage the home gateway in the home network from the external server outside the home network. However the related technologies don't disclose that the content playback is instructed by appointing the playback content and the playback order from the external server. Even though the related technologies described in Patent documents 2 and 3 are directly used, the service provider cannot carry out a content playback by appointing the playback content and the playback order from the outside of the home network.

Therefore an object of the invention is to provide a network system, a home gateway, a content playback method, and a network management program, in which a service provider can appoint playback content and playback order from the outside of the home network and play back the content in the home network.

### Means for Solving the Problem

A network of the present invention comprises a home gateway that manages a home network and an external server that can access the home network via an external network, wherein the home gateway comprises a playback list receiving means for downloading in advance and installing an OSGi bundle for remotely managing the home gateway from the external server, and receiving playback list data that can be used for specifying a list of playback content and the playback order of content from the external server, a playback content determination means for determining, on the basis of the playback list data, the playback content and the playback order of the content, and a playback instruction means for causing a device connected to the home network to playback the playback content in accordance with the playback order determined by the playback content determination means when a playback instruction for the content is received from the external server in accordance with the OSGi bundle.

A home gateway, for managing a home network, of the present invention, comprises a playback list receiving means for downloading in advance and installing an OSGi bundle for remotely managing the home gateway from an external server, and receiving playback list data which can be used for specifying a list of playback content and playback order of content from the external server, a playback content determination means for determining, on the basis of the playback list data, the playback content and the playback order of the content, and a playback instruction means for causing a device connected to the home network to playback the playback content in accordance with the playback order determined by the playback content determination means, when playback instruction for the content are received from the external server.

A content playback method of the present invention includes that downloading in advance and installing, by a home gateway which manages a home network an OSGi bundle for remotely managing the home gateway from an external server that can be access the home network via an external network, receiving, by the home gateway, playback list data that can be used specifying a list of playback content and playback order of content from the external server, determining, by the home gateway, on the basis of the playback list data, the playback content and the playback order of the content, and causing, by the home gateway, a device connecting to the home network to playback the playback content in accordance with the playback order determined by the home gateway, when a playback instruction for the content is received from the external server in accordance with the OSGi bundle, causes the playback content to be played on a device connected to the home network in the determined playback order.

A recording medium of the present invention for recording a network management program for management of a home network, causing a computer to execute the steps of receiving playback list data that can be used for specifying a list of playback content and playback order of content from an external server that can access to the home network via an external network, determining, on the basis of the playback list data, the playback content and the playback order of the content, and causing a device connected to the home network to playback the playback content in accordance with the determined playback order when a playback instruction for the content is received from the external server.

### Effect of the Invention

According to the invention, a service provider can appoint playback content and playback order from the outside of the home network and play the playback content in the home network.

### BRIEF DESCRIPTION ON THE DRAWING

FIG. 1 is a block diagram illustrating an example of a configuration of the network system using the content playback method of the invention.

FIG. 2 is a block diagram illustrating an example of a more specific configuration of the network system illustrated in FIG. 1.

FIG. 3 is an explanatory diagram illustrating a specific example of a play list.

FIG. 4 is a functional block diagram illustrating an example of a functional configuration of the network system illustrated in FIG. 1 and FIG. 2.

FIG. 5 is a flowchart illustrating an example of steps which are carried out before content provided by a service provider is downloaded to the home network side.

FIG. 6 is a flowchart illustrating an example of steps in which the contents are played back at the home network side in accordance with instructions from the service provider side.

FIG. 7 is a functional block diagram illustrating an example of a functional configuration of a network system in a second exemplary embodiment.

FIG. 8 is a flowchart illustrating an example of steps which are carried out before content provided by the service provider is downloaded to the home network side in the second exemplary embodiment.

FIG. 9 is a functional block diagram illustrating an example of a functional configuration of a network system in a third exemplary embodiment.

FIG. 10 is a flowchart illustrating an example of steps in which the content is played back at the home network side in accordance with instructions from the service provider side in the third exemplary embodiment.

FIG. 11 is a functional block diagram illustrating an example of a functional configuration of a network system in a fourth exemplary embodiment.

FIG. 12 is a flowchart illustrating an example of steps in which the content is played back at the home network side in accordance with instructions from the service provider side in the fourth exemplary embodiment.

FIG. 13 is a functional block diagram illustrating an example of a functional configuration of a network system in a fifth exemplary embodiment.

FIG. 14 is an explanatory diagram illustrating a specific example of a play list in the fifth exemplary embodiment.

FIG. 15 is a flowchart illustrating an example of steps in which the content is played back at the home network side in accordance with instructions from the service provider side in the fifth exemplary embodiment.

FIG. 16 is a functional block diagram illustrating an example of a functional configuration of a network system in a sixth exemplary embodiment.

FIG. 17 is a flowchart illustrating an example of steps in which the content is played back at the home network side in accordance with instructions from the service provider side in the sixth exemplary embodiment.

FIG. 18 is an explanatory diagram illustrating a specific example of a play list in the seventh exemplary embodiment.

FIG. 19 is a functional block diagram illustrating an example of the minimum functional configuration of a network system.

### MODE FOR CARRYING OUT THE INVENTION

An exemplary embodiment of the invention is described by referring to the drawings as described below. In a network system of an exemplary embodiment of the invention, a play list of content and the content are sent from an external server placed in an external network, e.g. Internet, to a HGW (Home Gateway), by using a standardized technology. And, when an instruction of a content playback is sent from the external server, arbitrary content on the network, e.g. advertisement, is played back at arbitrary time on a display device placed in a home network, and is provided to an end-user in response to a playback request from the external server. In the network system of the exemplary embodiment of the invention, a service provider can appoint the content, playback order, and playback timing and can send the content into the home network.

In addition, the network system in the exemplary embodiment of the invention can be applied to an application of providing a service, e.g. digital signage by the provider.

### Exemplary Embodiment 1

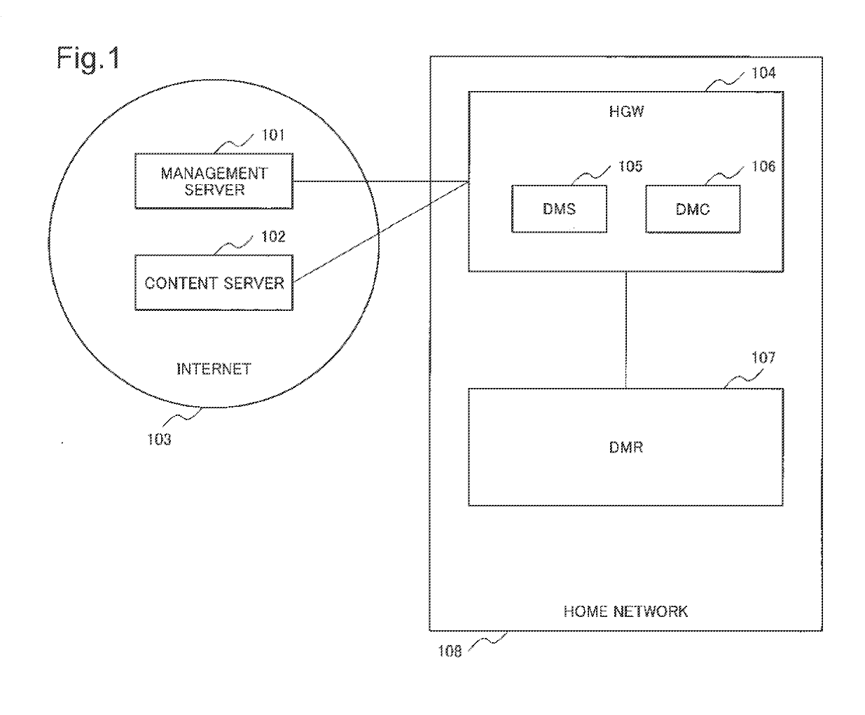

First, a first exemplary embodiment of the invention is described by referring to drawings. FIG. 1 is a block diagram illustrating an example of a configuration of a network system using the content playback method of the invention. As shown in FIG. 1, in the network system, a home network 108 is connected to Internet 103. The first exemplary embodiment shows a case where the home network 108 is connected to Internet 103 that is an external network. However, the external network may be a network outside the home network 108, e.g. an intranet, other than Internet.

As shown in FIG. 1, in the network system, a management server 101 is connected to a content server 102 through Internet 103. The management server 101 is specifically realized by an information processing device which is, for example, a personal computer operating in accordance with a program, and includes a function of managing content stored in the content server 102. And, the management server 101 stores a play list including playback order of the contents, a content title, a content storage area, and the like in a storage device (not shown).

The content server 102 is specifically realized by an information processing device which is, for example, a computer operating in accordance with a program. The content server 102 stores various content (e.g. various advertisement images) to be sent to a device (end-user's device) connected to the home network 108, in the storage device (not shown).

And, as shown in FIG. 1, in the network system, a HGW 104 and a DMR 107 are connected to each other through the home network 108. The HGW 104 is specifically realized by a network device, like a router. And, the HGW 104 may be realized by an information processing device which is, for example, a personal computer having a router function. In addition, the HGW 104 is also connected to Internet 103 and includes a function of receiving the play list through Internet 103.

And, the HGW 104 includes a DMC 106 and a DMS 105. The HGW 104 includes a function of downloading the content from the content server 102 through Internet 103, on the basis of the play list received from the management server 101, and of storing the content in the DMS 105.

In the first exemplary embodiment, the management server 101 sends a playback request to the HGW 104 through Internet 103 with arbitrary timing appointed by a service provider. And, the HGW 104 sends a playback instruction to the DMC 106 by using the function established in DLNA. And, the DMR 107 plays back the content stored in the DMS 105 in accordance with the instructions from the DMS 106.

The DMR 107 is specifically realized by a TV receiver, or various disc players, and includes a playback function for the content, like images.

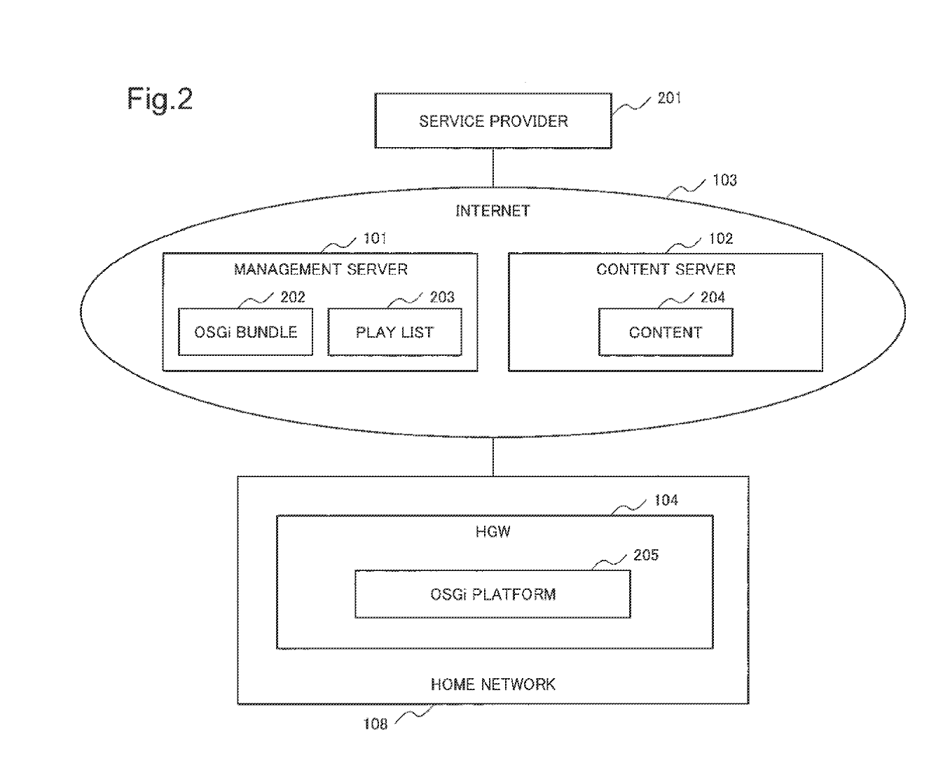

FIG. 2 is a block diagram illustrating an example of a further specific configuration of the network system illustrated in FIG. 1. As shown in FIG. 2, the HGW 104 includes a service platform for remotely managing the HGW 104 from the external server (e.g. the management server 101). In the first exemplary embodiment, as shown in FIG. 2, the HGW 104 includes an OSGi platform 205 established in OSGi (Open Services Gateway initiative) (e.g. a program for forming the platform is installed).

In the first exemplary embodiment, a service provider 201 preliminarily prepares content 204 which is intended to be provided to an end-user and be played back, and stores the content 204 in the storage device of the content server 102. And, the service provider 201 preliminarily prepares a list of playback content and a play list 203 that can specifies the playback order of the content, and stores them in a storage device of the management server 101. And, the service provider 201 preliminarily prepares an OSGi bundle 202 which carries out download and playback for content 204 in accordance with the play list 203, and stores the OSGi bundle 202 in the storage device of the management server 101. Additionally, the play list 203 and the OSGi bundle 202 are preliminarily made by the service provider 201 and stored in the storage device of the management server 101.

In addition, the first exemplary embodiment describes that the service provider 201 manages both the management server 101 and the content server 102. And, not being limited to these embodiments, each of the management server 101 and the content server 102, for example, may be managed by a different service provider. And, for example, the management server 101 and the content server 102 may be configured in the same information processing device. Each of the management server 101 and the content server 102 may be configured by a plurality of information processing devices.

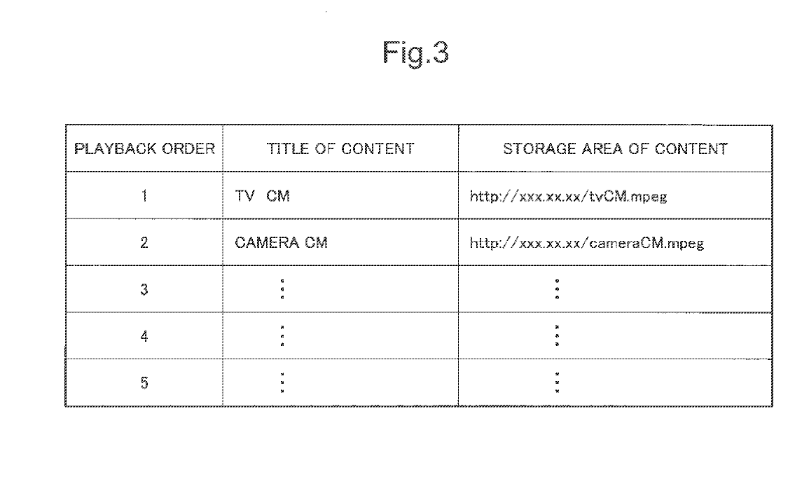

FIG. 3 is an explanatory diagram illustrating a specific example of the play list 203. As shown in FIG. 3, the management server 101 stores the play list 203 including the playback order of the content, a title of the playback content, the storage area of the playback content, and the like, which are associated with each other.

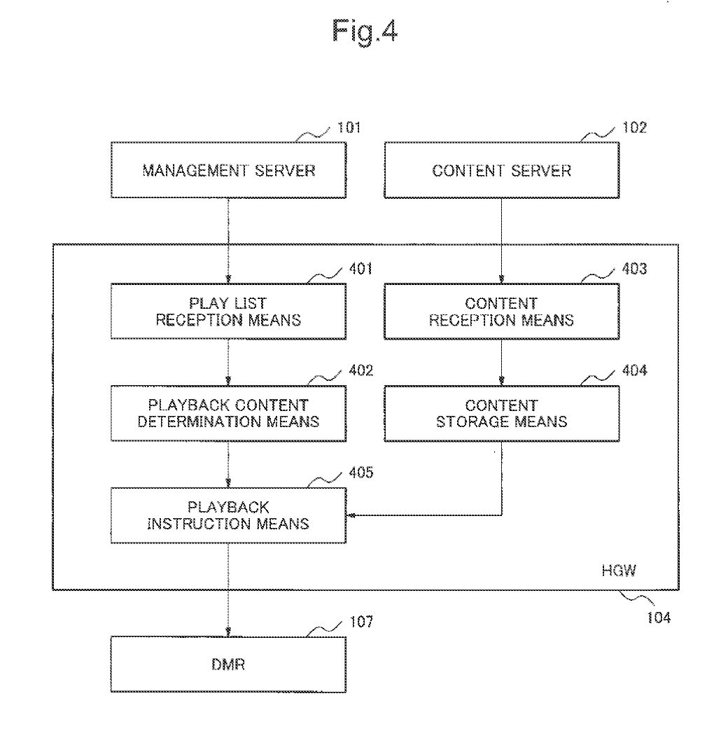

FIG. 4 is a functional block diagram illustrating an example of a functional configuration of the network system illustrated in FIG. 1 and FIG. 2. As shown in FIG. 4, in the network system, the HGW 104 includes, as a function forming means, a play list reception means 401, a playback content determination means 402, a content reception means 403, a content storage means 404, and a playback instruction means 405. And, in the first exemplary embodiment, the HGW 104 downloads and installs in advance the OSGi bundle 202 for remotely managing the HGW 104 from the management server 101.

The play list reception means 401 is specifically realized by a control unit and a communication unit of the HGW 104 operating in accordance with a program. The play list reception means 401 includes the function of receiving the play list 203 which can specify the list of the playback content and the playback order of the content, from the management server 101.

The playback content determination means 402 is specifically realized by the control unit of the HGW 104 operating in accordance with a program. The playback content determination means 402 includes the function of determining the playback contents and the playback order of the content on the basis of the play list 203 received by the play list reception means 401.

The content reception means 403 is specifically realized by the control unit and the communication unit of the HGW 104 operating in accordance with a program. The content reception means 403 includes the function of receiving content from the content server 102 through Internet 103.

The content storage means 404 is specifically realized by the storage device (corresponding to the DMS 105) comprised in the HGW 104. The content storage means 404 stores the content received by the content reception means 403.

The playback instruction means 405 is specifically realized by the control unit and the communication unit (corresponding to DMC 106) of the HGW 104 operating in accordance with a program. The playback instruction means 405 receives the playback instruction for the content from the management server 101 in accordance with OSGi handle 202. Next, the playback instruction means 405 instructs the DMR 107 connected to the home network 108 to play back the contents stored in the content storage means 404. In addition, the playback instruction means 405 further includes the function of playing back the playback contents in accordance with the playback order determined by the playback content determination means 402.

In addition, if the HGW 104 is realized by an information processing device which is a personal computer having a router function and the like, the storage device of the HGW 104 includes various programs for management of the home network 108. The storage device of the HGW 104 includes, for example, a network management program causing the computer to execute a step of receiving playback list data that can specify the list of the playback content and the playback order of the content from the external server that can access the home network via the external network, a step of determining, on the basis of the playback list data, the playback content and the playback order of the content, and a step of, when a playback instruction for the content is received from the external server, causing a device connected to the home network to playback the playback content according to the determined playback order in accordance with the OSGi bundle that is downloaded and installed in advance for remotely managing a home gateway, which manages the home network, from the external server.

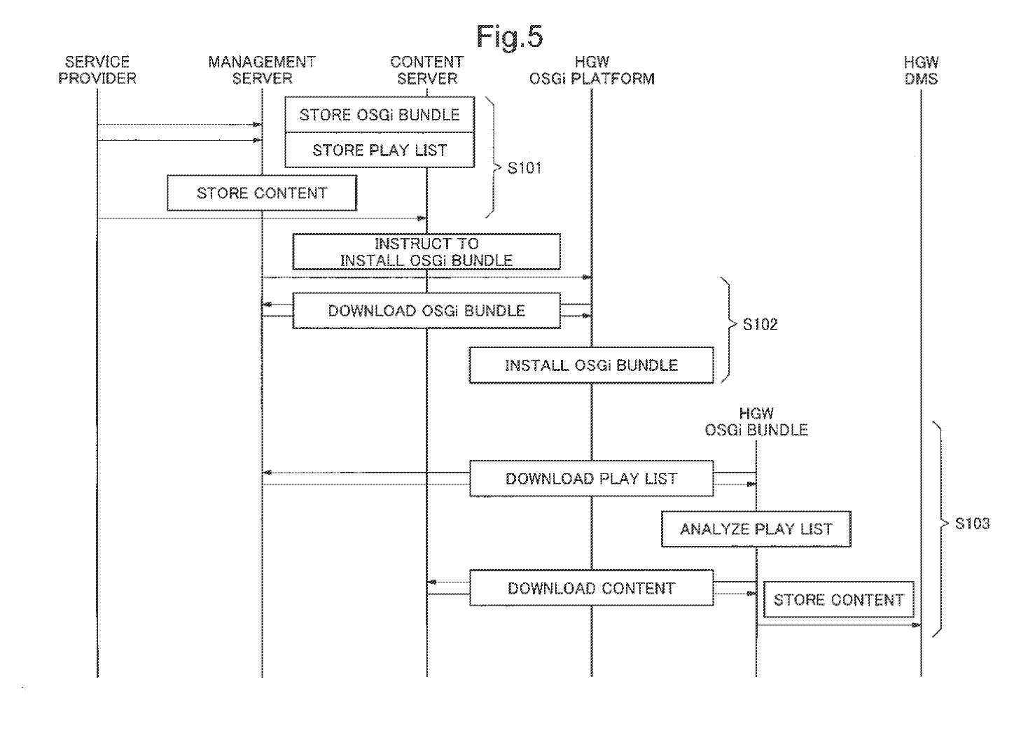

Next, operations are described. First, the operations, which are carried out before the content provided by the service provider 201 is downloaded in the home network 108 side, are described. FIG. 5 is a flowchart illustrating an example of the operations which are carried out before the content provided by the service provider 201 is downloaded in the home network 108 side.

As shown in FIG. 5, the service provider 201 makes the OSGi bundle 202 and the play list 203 in advance, and stores them in the management server 101. And, the service provider 201 preliminarily makes the content 204 provided to an end-user, and stores the content 204 in the content server 102 (step S101).

Next, the management server 101 sends an installing instruction for installing the OSGi bundle 202 to the HGW 104 through Internet 103, with predetermined timing. For example, the management server 101 can send the installing instruction at the time of first access from the HGW 104, and can search a HGW which is not installed and send the installing instructions at predetermined intervals.

When receiving the installing instruction, the HGW 104 downloads the OSGi bundle 202 from the management server 101 through Internet 103. The HGW 104 installs the downloaded OSGi bundle 202 (step S102).

Next, the HGW 104 downloads the play list 203 from the management server 101 in accordance with the installed OSGi bundle 202. Since the downloaded play list 203 includes information indicating the storage area of the content 204, the HGW 104 analyses the play list 203 in accordance with the OSGi bundle 202, and specifies the storage area of the content 204. And, the HGW 104 downloads, on the basis of the specified storage area, the content 204 from the content server 102 through Internet 103. And, the HGW 104 stores the downloaded content 204 in the DMS 105 of the HGW 104 (step S103). Additionally, in this case, the HGW 104 generates a content list including the stored content and the storage area in the DMS 105 which are associated with each other, and stores the content list in the DMS 105.

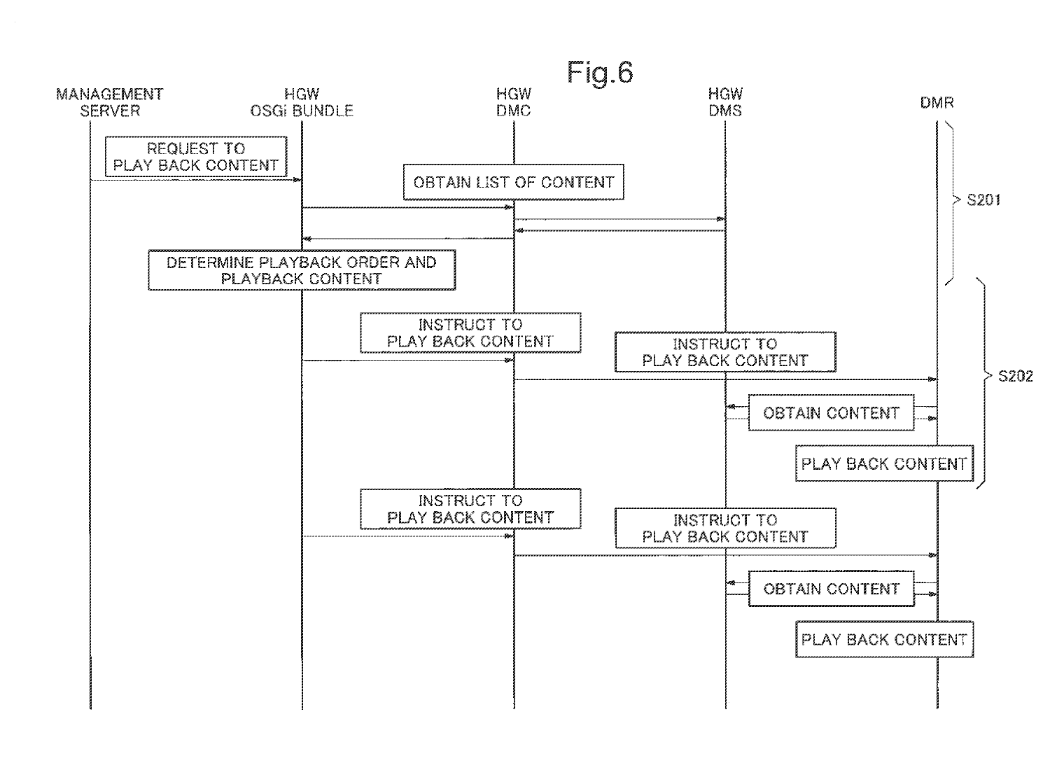

Next, operations, in which the content 204 is played back in the home network 108 side in accordance with instructions from the service provider 201 side, are described. FIG. 6 is a flowchart illustrating an example of steps in which the content 204 is played back in the home network 108 side in accordance with instructions from the service provider 201 side.

As shown in FIG. 6, the service provider 201 sends the playback instruction for the content 204 to the OSGi bundle 202 using the management server 101. For example, the management server 101 sends the playback instruction for the content 204 to the HGW 104 through Internet 103 with predetermined timing or at predetermined intervals. And, the HGW 104 obtains, in accordance with the OSGi bundle 202, the content list from the DMS 105 using the function established in DLNA (step 201). In other words, the HGW 104 extracts the content list from the DMS 105. The content list includes information indicating the list of the content stored in the DMS 105.

Next, the HGW 104 specifies the title of the content and the playback order, on the basis of the play list 203 downloaded in step S103, in accordance with the OSGi bundle 202. And, the HGW 104 determines the playback content 204 and the playback order on the basis of the specified title of the content, the playback order, and the information indicating the list of the content extracted from the content list.

Next, the HGW 104 sends the playback instruction for the content 204 to the DMC 106 using the function established in DLNA, in accordance with the OSGi bundle 202. And, the DMC 106 sends the playback instruction for the content to the DMR 107 through the home network 108. And, the DMR 107 extracts the content 204 from the DMS 105 through the home network 108 in accordance with the instructions of the DMC 106, and plays back the extracted content 204 (step S202).

As described above, according to the first exemplary embodiment, the HGW 104 determines the playback content and the playback order on the basis of the play list 203 downloaded from the management server 101. And, when receiving the playback instruction from the service provider 201, the HGW 104 causes the DMR 107 to play back the content in accordance with the OSGi bundle 202 downloaded from the management server 101. Therefore, the service provider 201 can play back the content 204 in the home network 108 by appointing, from the outside of the home network 108, the playback content 204 and the playback order.

And, according to the first exemplary embodiment, the service provider 201 can play back arbitrary content with arbitrary timing from the outside of the home network 108 (through Internet), to an end-user.

And according to the first exemplary embodiment, since the platform which achieves the above functions can be formed by using the technology standardized by the OSGi, DLNA, or the like, a system can be developed at low cost.

And according to the first exemplary embodiment, since DLNA devices which are commercially available can be used as a playback device, an end-user has no new burden. Further, a new service can be developed by using the DLNA devices except the DMR, like a DMPr (Digital Media Printer), as the playback device.

### Exemplary Embodiment 2

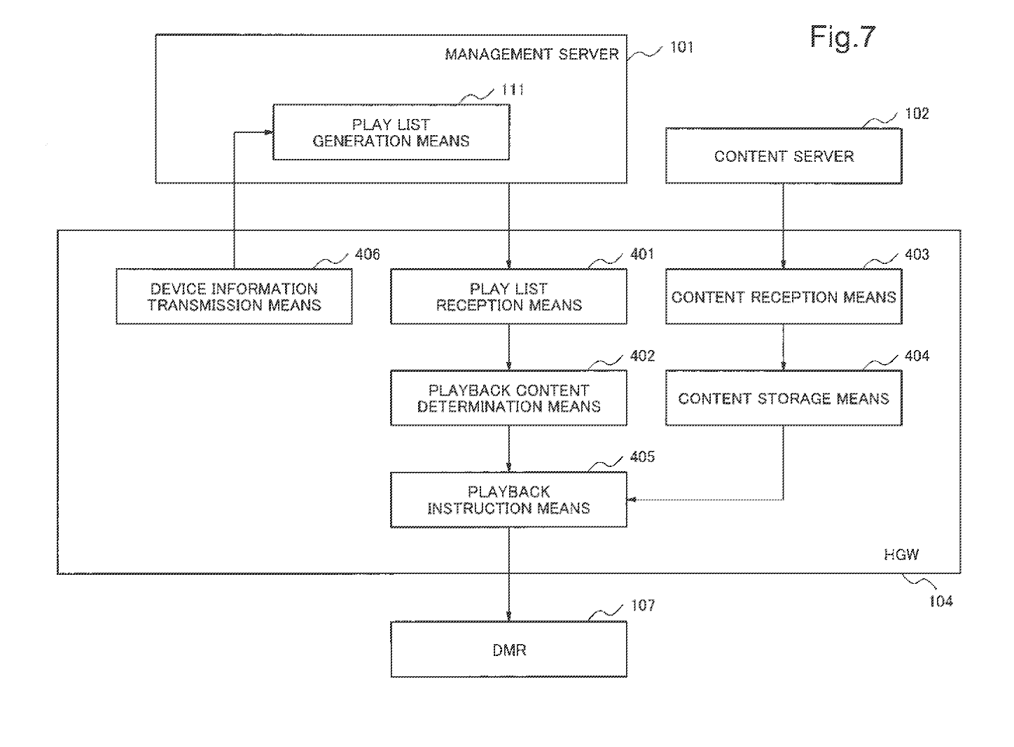

Next, a second exemplary embodiment of the invention is described. FIG. 7 is a functional block diagram illustrating an example of a functional configuration of a network system in the second exemplary embodiment. As shown in FIG. 7, in the second exemplary embodiment, the management server 101 includes a play list generation means 111. And, in the second exemplary embodiment, the HGW 104 includes a device information transmission means 406 in addition to the elements shown in the first exemplary embodiment.

The device information transmission means 406 is specifically realized by the control unit and the communication unit of the HGW 104 operating in accordance with a program. The device information transmission means 406 includes a function of transmitting device information by which a device connected to the home network 108 can be specified, to the management server 101. In FIG. 7, the device connected to the home network 108 is the DMR 107. And, the HGW 104 may preliminarily register the device information in accordance with operations of an end-user, or may preliminarily receive the device information from the device connected to the home network 108 (DMR 107 in the example).

The play list generation means 111 is specifically realized by a CPU in the information processing device operating in accordance with a program, and a network interface unit. The play list generation means 111 includes a function of generating the play list 203. In the second exemplary embodiment, the play list generation means 111 specifies the device connected to the home network 108 (DMR 107 in the example) on the basis of the device information received from the HGW 104. And, the play list generation means 111 specifies the content corresponding to the specified device and generates the play list 203.

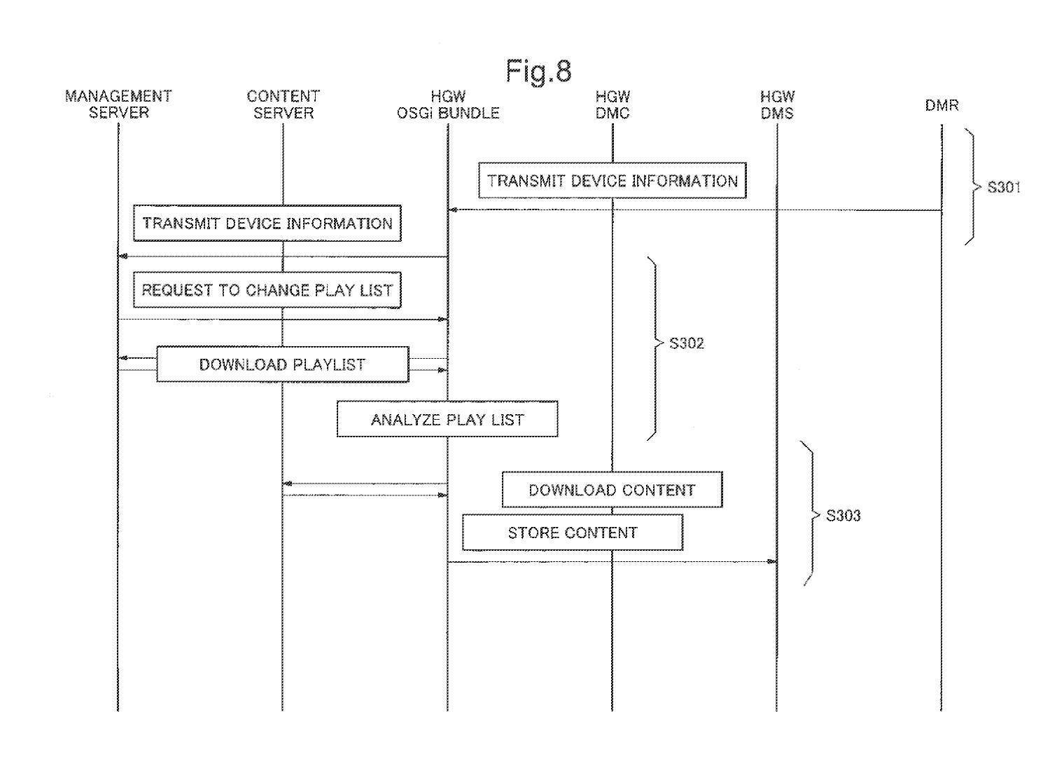

FIG. 8 is a flowchart illustrating an example of steps which are carried out before the content provided by the service provider 201 is downloaded in the home network 108 side in the second exemplary embodiment.

As shown in FIG. 8, the HGW 104 obtains the device information by which the DMR 107 located in the home network 108 can be specified, and the HGW 104 transmits the device information to the management server 101 through Internet 103 (step S301).

Next, the management server 101 generates again, on the basis of the received device information, the play list 203. And, the management server 101 requests the OSGi bundle 202 installed in the HGW 104 to change the play list 203 through Internet 103. And, the HGW 104 downloads again the play list 203 (playlist 203 generated again) from the management server 101 through Internet 103, in accordance with the OSGi bundle 202, and analyzes again the play list 203 (step S302).

Next, the HGW 104 downloads again the content 204, on the basis of the result of the analysis of the new play list 203, in accordance with the OSGi bundle 202, and stores the content 204 in the DMS 105 (step S303).

In addition, the second exemplary embodiment shows that the play list 203 is generated again by receiving the device information, after the OSGi bundle 202 and the play list 203 are once downloaded. The timing of regeneration of the play list 203 is not limited to the timing described in the second exemplary embodiment. For example, the device information may be transmitted in advance before the OSGi bundle 202 and the play list 203 are downloaded, and after the play list 203 is generated on the basis of the device information, the OSGi bundle 202 may be downloaded together with the generated play list 203.

As described above, according to the second exemplary embodiment, the service provider 201 can make again the play list 203 for playing back the content 204 related to the device information again on the basis of the device information in the home network 108, and can change the playback content 204. Therefore the appropriate content corresponding to the device in the home network 108 can be played back.

### Exemplary Embodiment 3

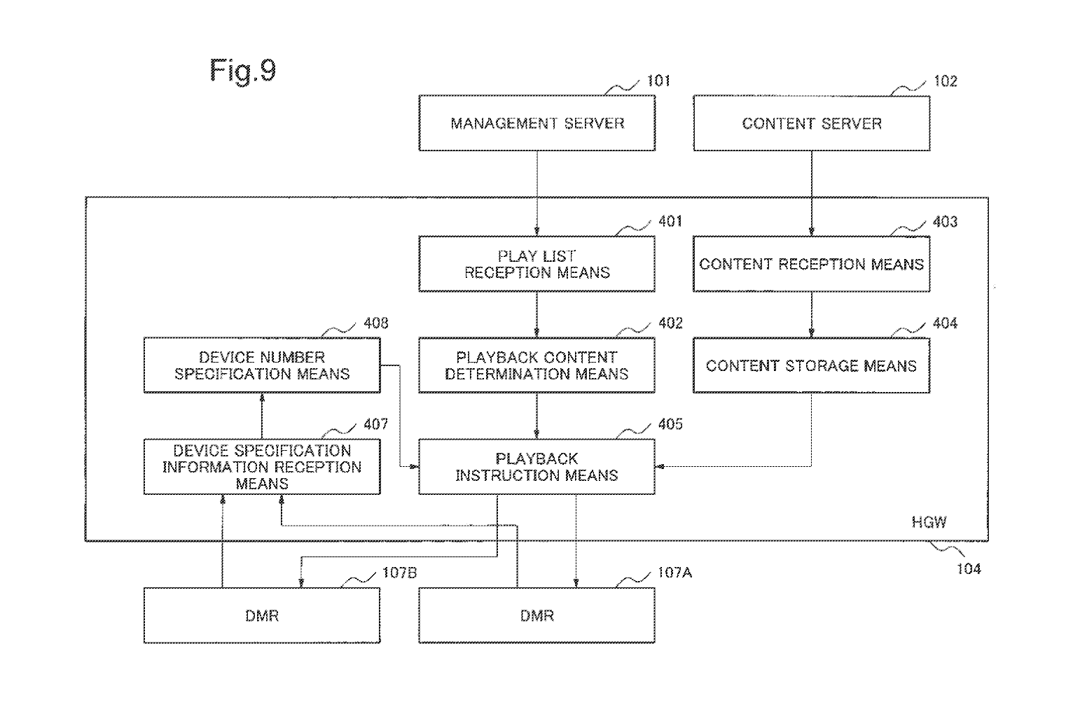

Next, a third exemplary embodiment of the invention is described. FIG. 9 is a functional block diagram illustrating an example of a functional configuration of a network system in the third exemplary embodiment. As shown in FIG. 9, in the third exemplary embodiment, the network system includes a DMR 107A and a DMR 107B. And, in the third exemplary embodiment, the HGW 104 includes a device specification information reception means 407 and a content storage means 404 in addition to the elements described in the first exemplary embodiment. In addition, the third exemplary embodiment describes that the number of devices, which are connected to the home network 108, is two except the HGW 104. However, three or more devices may be connected thereto.

The device specification information reception means 407 is specifically realized by the control unit and the communication unit in the HGW 104 operating in accordance with a program. The device specification information reception means 407 includes a function of receiving device specification information by which the device can be specified, from the devices connected to the home network 108 (DMR 107A, DMR 107B in the example).

A device number specification means 408 is specifically realized by the control unit in the HGW 104 operating in accordance with a program. The device number specification means 408 includes a function of specifying, on the basis of the received device specification information, the number of the devices connected to the home network 108.

And, in the third exemplary embodiment, when receiving the playback instruction for the content from the management server 101, a playback instruction means 405 determines the device which plays back the content on the basis of the specified result of the device number specification means 408, in accordance with the OSGi bundle 202. And, the playback instruction means 405 causes the determined device to play back the content. In addition, for example, the playback instruction means 405 may cause both the DMR 107A and the DMR 107B to play back the same content at the same time, or cause the DMR 107A and the DMR 107B to alternately play back each of the content.

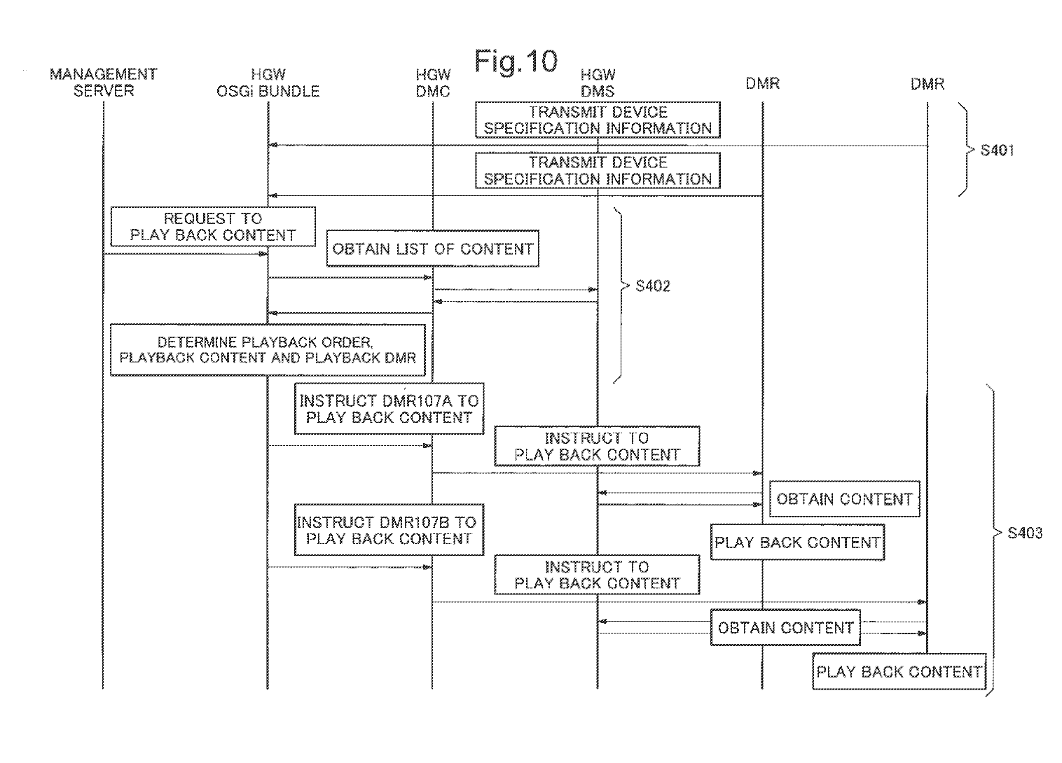

FIG. 10 is a flowchart illustrating an example of steps in which the content is played back at the home network 108 side in accordance with the instructions from the service provider 201 side in the third exemplary embodiment.

As shown in FIG. 10, when a plurality of the DMR 107A and the DMR 107B are located in the home network 108, each of the plurality of the DMR 107A and the DMR 107B transmits the device specification information to the OSGi bundle 202 of the HGW 104 through the home network 108 (step S401). The HGW 104 can therefore understand that the plurality of the DMR 107A and the DMR 107B are located in the home network 108, in accordance with the OSGi bundle 202.

Next, when receiving the playback instruction from the management server 101, the HGW 104 determines playback order of the content and the playback content 204, and determines the DMR 107A and the DMR 107B for playback (step S402). And, the HGW 104 sends a playback instruction corresponding to the determination result to each of the DMR 107A and the DMR 107B (step S403).

As described above, according to the third exemplary embodiment, since the number of the devices in the home network 108 can be specified in advance on the basis of the device specification information, it is possible to cause the DMR 107A and the DMR 107B to play back the content. Effect of playing back the content can be much improved, for example, by sharing roles among the plurality of the DMR 107A and the DMR 107B.

### Exemplary Embodiment 4

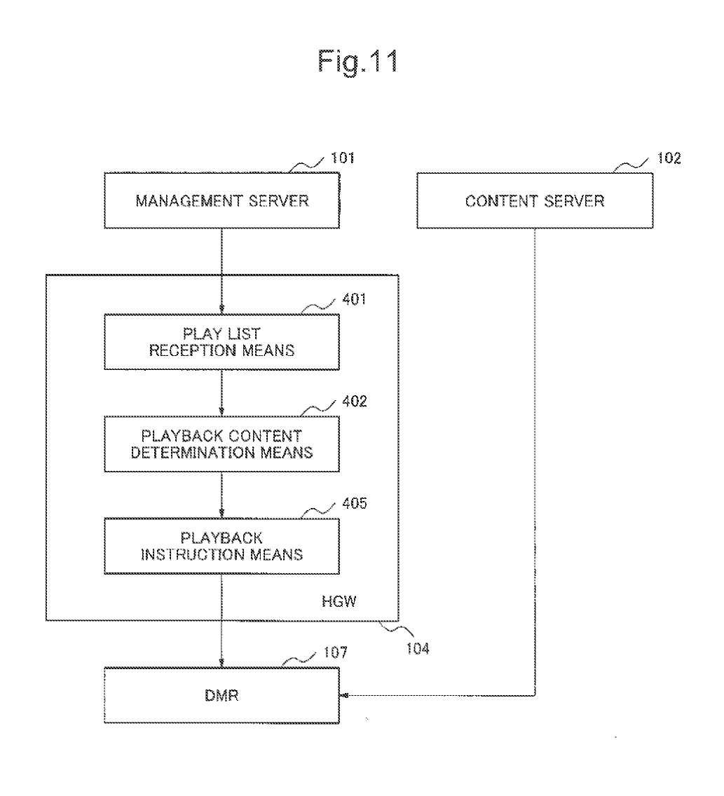

Next, a fourth exemplary embodiment of the invention is described. FIG. 11 is a functional block diagram illustrating an example of a functional configuration of a network system in the fourth exemplary embodiment. As shown in FIG. 11, in the fourth exemplary embodiment, the HGW 104 does not include the content reception means 403 and the content storage means 404 which are described in the first exemplary embodiment, and the DMR 107 directly receives the content 204 from the content server 102 and plays back the content 204.

In the fourth exemplary embodiment, when receiving the playback instruction of the content from the management server 101 in accordance with the OSGi bundle 202, the playback instruction means 405 appoints the storage area of the content on Internet 103 and instructs the device connected to the home network 108 (DMR 107 in the example) to play back the content. In addition, for example, the playback instruction means 405 has only to specify the storage area of the content 204 on the content server 102 on the basis of the play list 203, directly appoint the specified area, and transmit the playback instruction for the content.

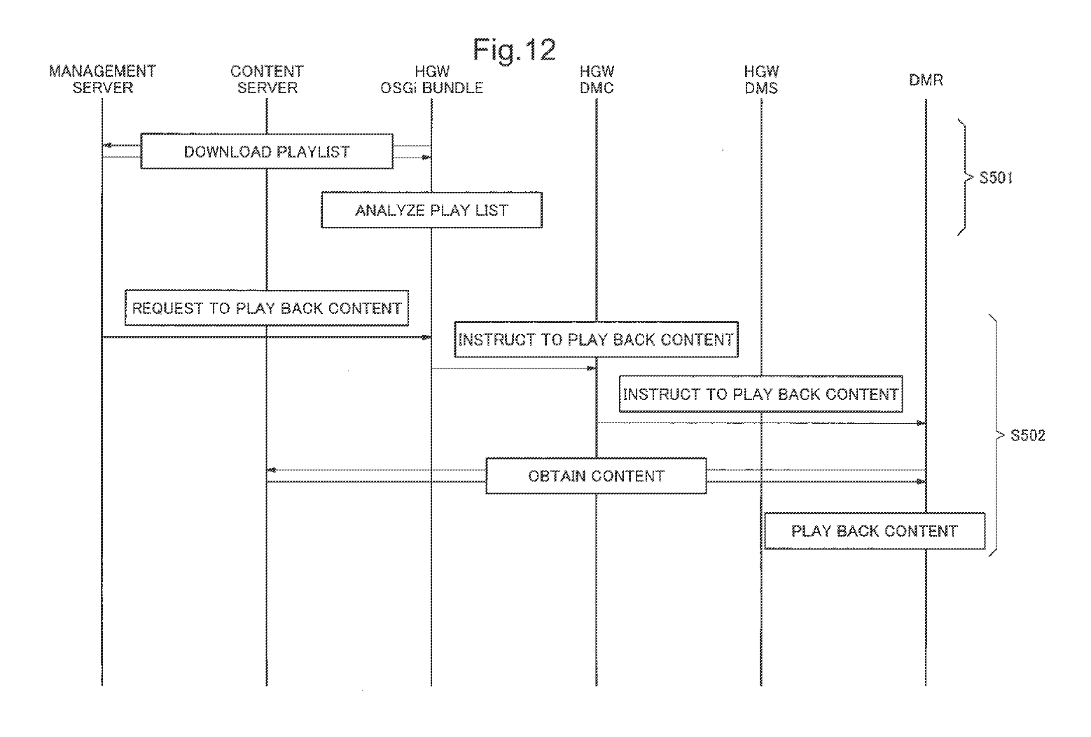

FIG. 12 is a flowchart illustrating an example of steps in which the content 204 is played back in the home network 108 side in accordance with the instructions from the service provider 201 side in the fourth exemplary embodiment.

As shown in FIG. 12, in the fourth exemplary embodiment, when downloading the play list 203, in accordance with the OSGi bundle 202, the HGW 104 only analyzes the play list 203 and doesn't download and storage the content 204 (step S501).

In the fourth exemplary embodiment, when receiving a playback request from the management server 101 and causing the DMC 106 to send the playback instruction, the HGW 104 sends the playback instruction by appointing the storage area in the content server 102 as the storage area of the content 204. And the DMR 107 directly receives the content 204 from the content server 102 through Internet 103 and the home network 108 in accordance with the instruction from the HGW 104. Next, the DMR 107 plays back the received content (step S502).

As described above, according to the fourth exemplary embodiment, it is possible to play back the content 204 without downloading the content 204 in advance. Therefore, a storage capacity in the HGW 104 side can be reduced, and the burden for processes of the HGW 104 can be reduced.

### Exemplary Embodiment 5

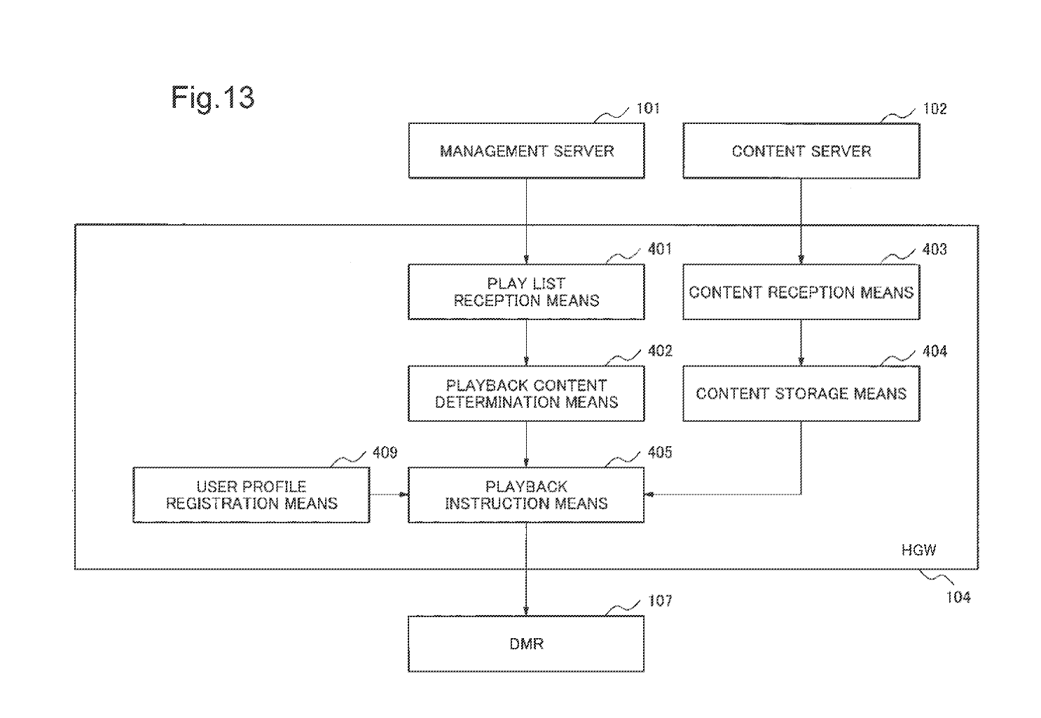

Next, a fifth exemplary embodiment of the invention is described. FIG. 13 is a functional block diagram illustrating an example of a functional configuration of a network system in the fifth exemplary embodiment. As shown in FIG. 13, in a fifth exemplary embodiment, the HGW 104 includes a user profile registration means 409 in addition to the elements described in the first exemplary embodiment.

The user profile registration means 409 is specifically realized by the control unit in the HGW 104 operating in accordance with a program. The user profile registration means 409 includes a function of preliminarily registering user profile information indicating attributes, e.g. tastes of end-users.

And, in the fifth exemplary embodiment, the play list reception means 401 receives the play list 203 which includes content profile information indicating attributes of the content. And, in the fifth exemplary embodiment, the playback content determination means 402 determines, as the playback content, the content corresponding to the attribute represented by the user profile information in the content specified by the play list 203, on the basis of the attributes indicated by the content profile information.

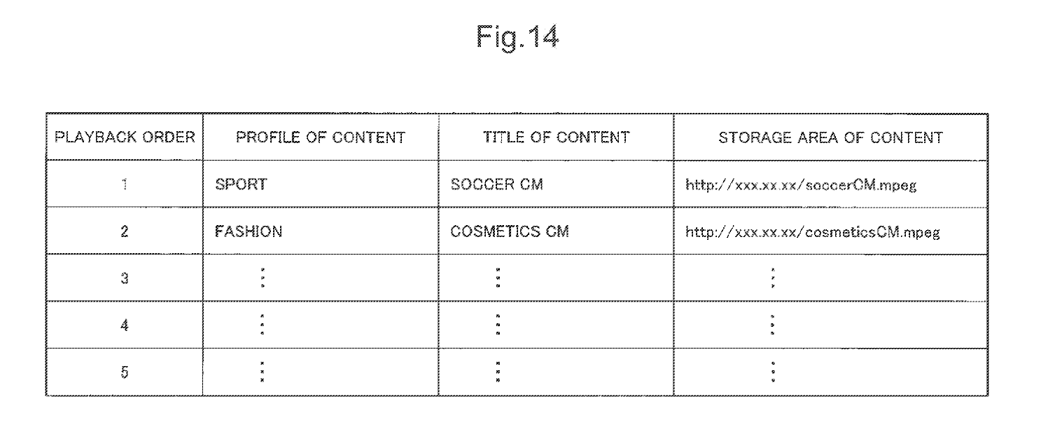

FIG. 14 is an explanatory diagram illustrating a specific example of the play list 203 in the fifth exemplary embodiment. As shown in FIG. 14, in the fifth exemplary embodiment, the play list 203 includes the content profile information indicating the attributes of the content, which is associated with the content, in addition to the information described in the first exemplary embodiment.

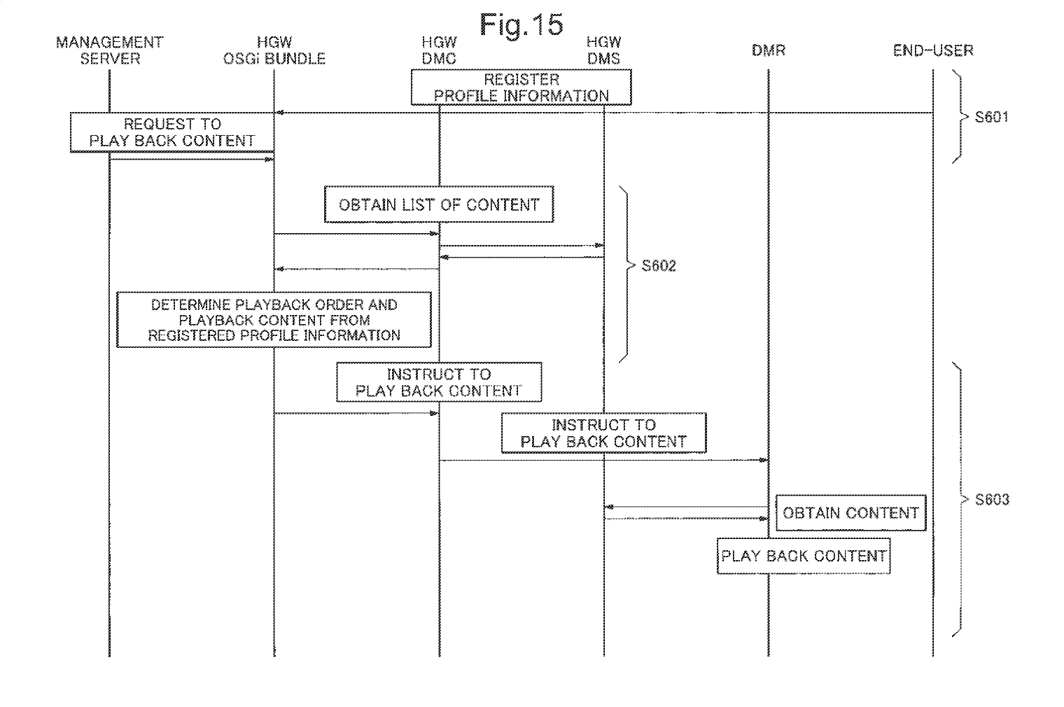

FIG. 15 is a flowchart illustrating an example of steps in which the content is played back at the home network 108 side in accordance with instructions from the service provider 201 side in the fifth exemplary embodiment.

As shown in FIG. 15, an end-user makes the user profile information including the attributes, e.g. the user's hobby, like sport, or the like, and registers the information into the OSGi bundle 202 in the HGW 104 by using GUI (Graphical User Interface), or the like on Web. In this case, the HGW 104 registers the user profile information in a storage device in response to a registration request from a user terminal, in accordance with the OSGi bundle 202 (step S601).

Next, when receiving the playback request from the management server 101, the HGW 104 determines the playback order of the content and the playback content 204, in accordance with the OSGi bundle 202, so that only the content 204 corresponding to the attributes indicated by the user profile information is played back (step S602). And, the HGW 104 causes the DMR 107 to play back the content on the basis of the determination result (step S603).

As described above, according to the fifth exemplary embodiment, since only the content 204 corresponding to the attribute indicated by the user profile information is played back, only the content 204 which the end-user wants to see can be played back.

### Exemplary Embodiment 6

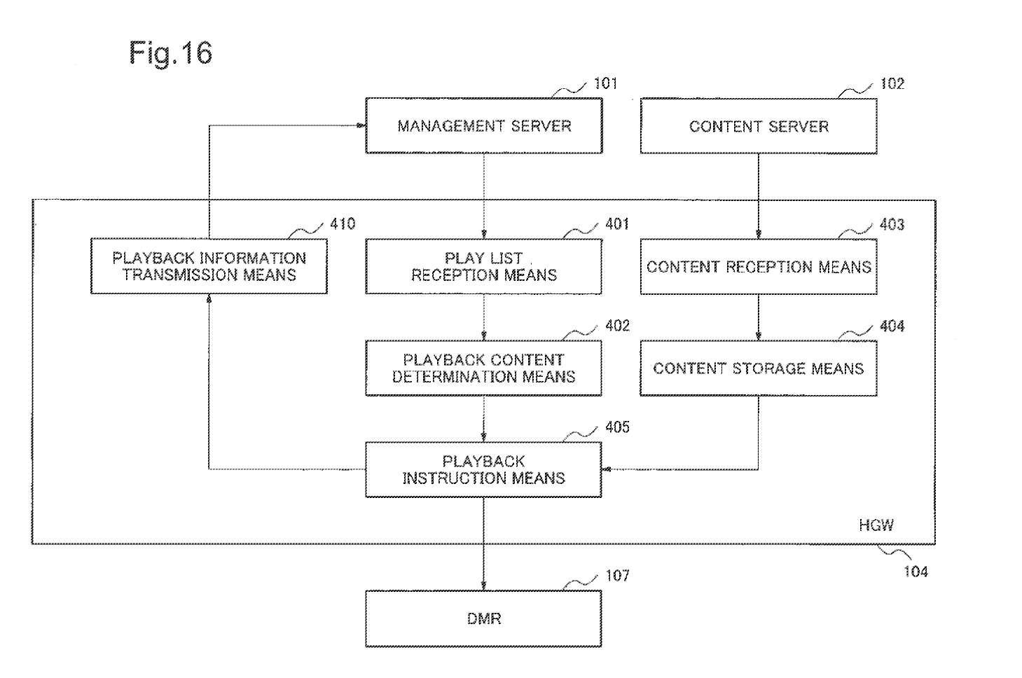

Next, a sixth exemplary embodiment of the invention is described. FIG. 16 is a functional block diagram illustrating an example of a functional configuration of a network system in the sixth exemplary embodiment. As shown in FIG. 16, in a sixth exemplary embodiment, the HGW 104 includes a playback information transmission means 410 in addition to the elements described in the first exemplary embodiment.

The playback information transmission means 410 is specifically realized by the control unit and the communication unit of the HGW 104 operating in accordance with a program. In addition, the playback information transmission means 410 includes a function of generating the content playback information indicating a playback state of the content 204, and of transmitting the generated content playback information to the management server 101 through Internet 103. And, the playback information transmission means 410 generates, for example, a number of the playback and a time of the playback for each of the content, and information indicating the played content 204, as the content playback information, and transmits them to the management server 101.

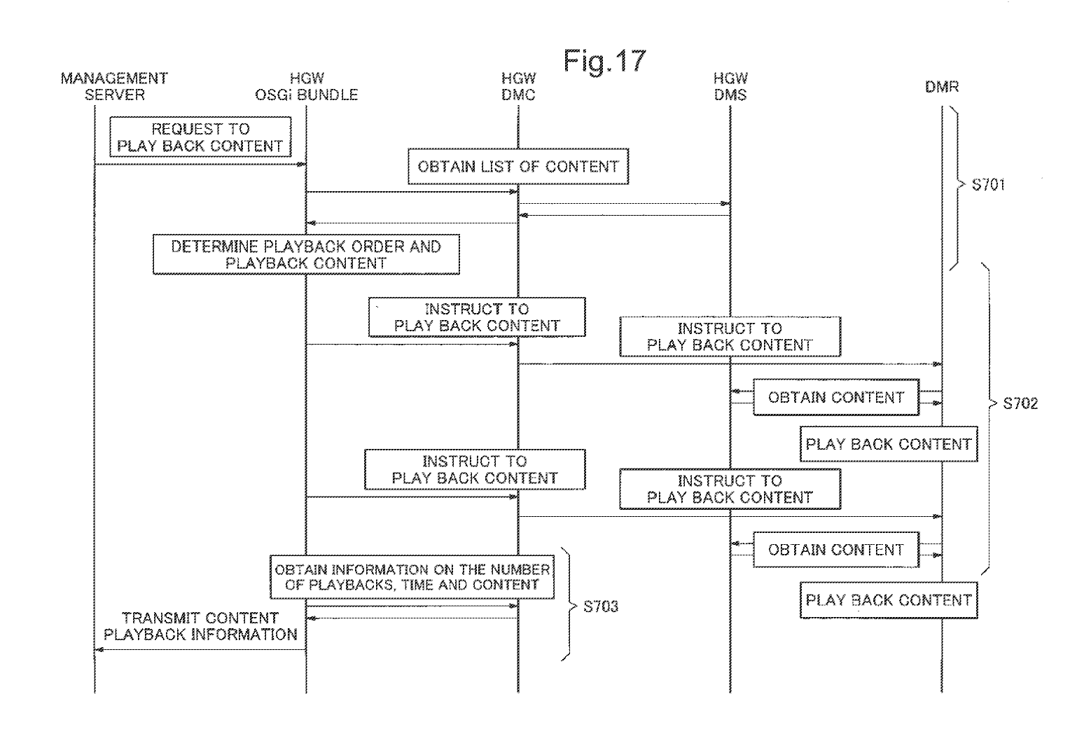

FIG. 17 is a flowchart illustrating an example of steps in which the content is played back at the home network 108 side in accordance with instructions from the service provider 201 side in the sixth exemplary embodiment.

As shown in FIG. 17, when receiving the playback request from the management server 101, the HGW 104 determines the playback order of the content and the playback content 204, in accordance with the OSGi bundle 202 (step S701). And, the DMC 106 sends the playback instruction to the DMR 107 on the basis of the determination result (step S702). Since the playback instruction is sent from the HGW 104, the OSGi bundle 202 and the DMC 106 in the HGW 104 can obtain and store the information about the played content 204.

Therefore, the HGW 104 extracts the number and the time of the playback of the content 204 and the information indicating the played content 204, which are stored in the DMC 106, in accordance with the OSGi bundle 202. And, the HGW 104 generates the number and the time of the playback of the content 204 stored in the DMC 106 and the content playback information indicating the played content 204. And the HGW 104 transmits the generated content playback information to the management server 101 through Internet 103 (step S703).

As described above, according to the sixth exemplary embodiment, when the content playback information is transmitted to the service provider 201 after the fact, the service provider 201 can obtain the information about the end-user. Therefore, since the service provider 201 measures the information indicating the content 204 played in the end-user's house, the number and the time of the playback, the service provider 201 can understand a sending state of the content 204. And. since the service provider 201 can obtain the information about an end-user through a carrier, the service provider 201 can provide new services, e.g. a filtering of the content 204, a profits return depending on the number and the time of the playback, or the like.

### Exemplary Embodiment 7

Next, an exemplary embodiment 7 of the invention is described. Additionally, in the exemplary embodiment 7, a configuration of the network system is the same as that of the first exemplary embodiment.

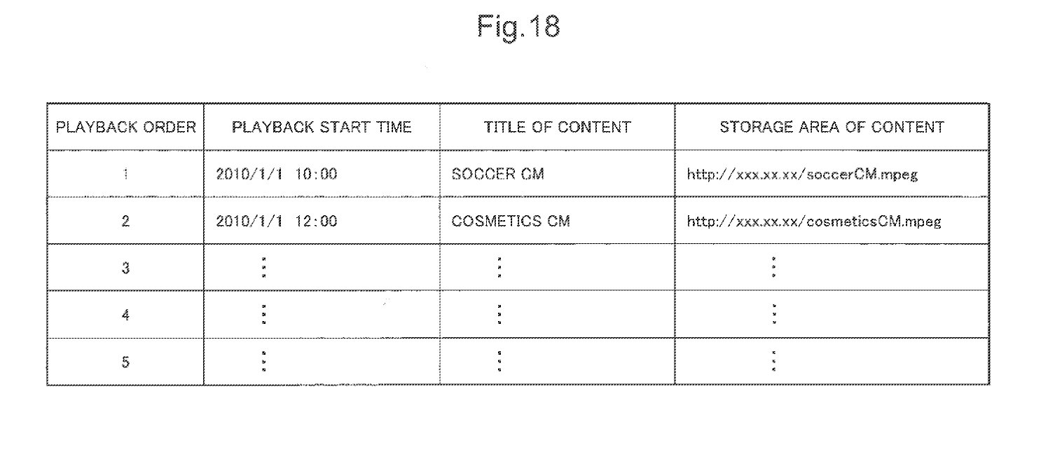

FIG. 18 is an explanatory diagram illustrating a specific example of a play list 203 in the seventh exemplary embodiment. As shown in FIG. 18, in the seventh exemplary embodiment, the play list 203 includes information indicating a playback start time (start time) of the content 204 (hereinafter, referred to as “playback time information”), which is associated with the content, in addition to the information described in the first exemplary embodiment.

In the seventh exemplary embodiment, the play list reception means 401 receives the play list 203 including the playback time information shown in FIG. 18. And, the playback instruction means 405 causes the device connected to the home network 108 (DMR 107 in the example) to play back the content, on the basis of the coming of the playback start time indicated by the playback time information, in accordance with OSGi bundle 202.

As described above, according to the seventh exemplary embodiment, it is possible to play back the content 204 at a predetermined time, on the basis of the playback time information included in the play list 203, in accordance with OSGi bundle 202.

In addition, the network system may be realized by one of configurations of the first exemplary embodiment to the seventh exemplary embodiment, or may be realized by any combination of the configurations of the first exemplary embodiment to the seventh exemplary embodiment. Further, for example, the network system may be realized by combination of all of the configurations of the first exemplary embodiment to the seventh exemplary embodiment.

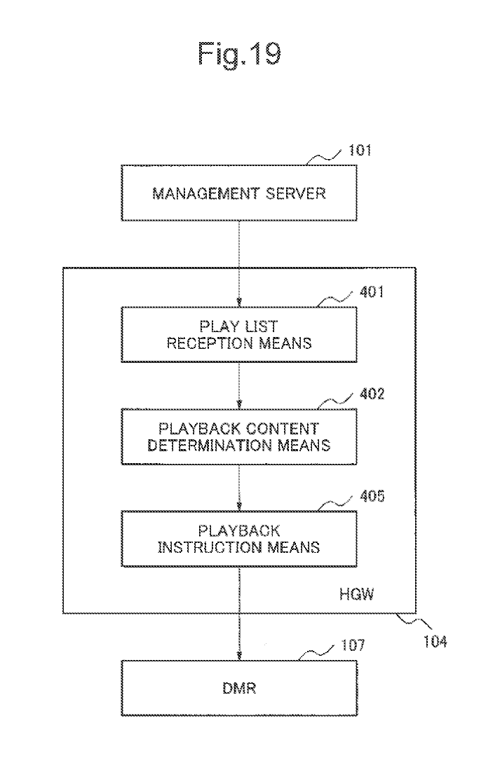

Next, the minimum configuration of the network system of the invention is described. FIG. 19 is a functional block diagram illustrating an example of the minimum functional configuration of the network system. As shown in FIG. 19, the network system includes the HGW 104 which manages the home network, and the management server 101 which can access the home network through the external network. And the HGW 104 downloads and installs in advance an OSGi bundle for remotely managing the HGW 104 from the management server 101, and includes the play list reception means 401, the playback content determination means 402, and the playback instruction means 405.

The play list reception means 401 includes a function of receiving, from the management server 101, the play list by which the list of the playback content and the playback order of the content can be specified. And, the playback content determination means 402 includes a function of determining, on the basis of the play list, the playback content and the playback order of the content. And the playback instruction means 405 includes a function of causing the DMR 107 connected to the home network to play back the playback content according to the playback order determined by the playback content determination means 402, when the playback instruction for the content is received from the management server 101, in accordance with OSGi bundle 202.

According to the network system having the minimum configuration shown in FIG. 19, the service provider can play back the content in the home network by appointing the playback content and the playback order from the outside of the home network.

In addition, the exemplary embodiments described above disclose characteristic configurations of the network system and the home gateway as described in the following (1) to (9).
(1) A network system comprises a home gateway (e.g. HGW 104) that manages a home network (e.g. home network 108), and an external server (e.g. management server 101) that can access the home network via an external network (e.g. Internet 103), wherein the home gateway comprises a playback list receiving means (e.g. realized by play list reception means 401) for downloading in advance and installing an OSGi bundle for remotely managing the home gateway from the external server (e.g. OSGi bundle 202), and receiving playback list data that can be used for specifying a list of the playback content and playback order of the content (e.g. play list 203) from the external server, a playback content determination means (e.g. realized by playback content determination means 402) for determining, on the basis of the playback list data, the playback content and the playback order of the content, and a playback instruction means (e.g. realized by playback instruction means 405) for causing a device (e.g. DMR 107) connecting to the home network to playback the playback content in accordance with the playback order determined by the playback content determination means, when a playback instruction for the playback content are received from the external server in accordance with the OSGi bundle.
(2) In the network system, the home gateway may be configured to comprise the device information transmission means (e.g. realized by device information transmission means 406) for transmitting, to the external sever, the device information that can be used for specifying the device connected to the home network (e.g. device information), wherein the external server may be configured to comprise the playback list generation means (e.g. realized by play list generation means 111) for generating the playback list data, wherein the playback list generation means may be configured to specify the device connected to the home network on the basis of the device information received from the home gateway, and generates the playback list data by specifying content corresponding to the specified device.
(3) In the network system, the home gateway may be configured to comprise the device information reception means (e.g. realized by device specification information reception means 407) for receiving, from the device connected to the home network, a device specification information which can be used for specifying the device, and a device number specification means (e.g. realized by device number specification means 408) for specifying the number of the devices connected to the home network on the basis of the received device specification information, wherein the playback instruction means determines the device that plays back the content in accordance with the specified result of the device number specification means, and causes the determined device to play back the content, when receiving the playback instruction for the content from the external server.
(4) In the network system, the home gateway may be configured to comprise the content reception means (e.g. realized by content reception means 403) for receiving the content from the external network, and the content storage means (e.g. realized by content storage means 404) for storing the content received by the content reception means, wherein the playback instruction means may be configured to instruct the device connected to the home network to play the content stored by the content storage means.
(5) In the network system, the playback instruction means, when receiving the playback instruction for the content, may be configured to appoint a storage area of the content on the external network, and instruct the device connected to the home network to play back the content.
(6) In the network system, the home gateway may be configured to comprise the user attribute registration means (e.g. realized by user profile registration means 409) for preliminarily registering the user attribute information (e.g. user profile information) indicating the user attribute, the playback list receiving means may be configured to receive the playback list data including the content attribute information (e.g. content profile information) indicating the content attribute, and the playback content determination means may be configured to select, as the playback content, the content corresponding to an attribute indicated by the user attribute information among the content specified by the playback list data, on the basis of an attribute indicated by the content attribute information.
(7) In the network system, the home gateway may be configured to include the playback information transmission means (e.g. realized by playback information transmission means 410) for transmitting the content playback information (e.g. content playback information) indicating a state of the content playback.
(8) In the network system, the playback list receiving means may be configured to receive the playback list data including playback time information (e.g. playback time information) indicating time of the content playback, and the playback instruction means may be configured to cause the device connected to the home network to play back the content, on the basis of the coming of the time of the content playback indicated by the playback time information.
(9) The home gateway (e.g. HGW 104) for managing the home network (e.g. home network) comprises a playback list receiving means (e.g. realized by play list reception means 401) for downloading and installing in advance the OSGi bundle (e.g. OSGi bundle 202) for remotely managing the home gateway from the external server (e.g. management server 101) which can access the home network via the external network (e.g. Internet 103), and receiving, from the external server, playback list data (e.g. play list 203) which can be used for satisfying a list of the playback content and the playback order of the playback content, a playback content determination means (e.g. realized by playback content determination means 402) for determining, on the basis of the playback list data, the playback content and the playback order of the content, and a playback instruction means (e.g. realized by playback instruction means 405) for causing a device (e.g. DMR 107) connecting to the home network to playback the playback content in accordance with the playback order determined by the playback content determination means, when a playback instruction for the content is received from the external server in accordance with the OSGi bundle.

While the invention has been particularly shown and described with reference to exemplary embodiments thereof, the invention is not limited to these embodiments. It will be understood by those of ordinary skill in the art that various changes in form and details may be made therein without departing from the spirit and scope of the present invention as defined by the claims.

This application is based upon and claims the benefit of priority from Japanese patent application No. 2011-025244, filed on Feb. 8, 2011, the disclosure of which is incorporated herein in its entirety by reference.

The whole or part of the exemplary embodiments disclosed above can be described as, but not limited to, the following supplementary notes.

### Supplemental Note 1

In the network system, the playback list reception means receives the playback list data including the playback time information indicating the time of the content playback, and the playback instruction means causes the device connected to the home network to play back content on the basis of the coming of the time of the content playback indicated by the playback time information.

### Explanation on Reference Numeral

101 management server

102 content server

103 Internet

104 HGW

105 DMS

106 DMC

107 DMR

108 home network

111 play list generation means

201 service provider

202 OSGi bundle

203 play list

204 content

205 OSGi platform

401 play list reception means

402 playback content determination means

403 content reception means

404 content storage means

405 playback instruction means

406 device information transmission means

407 device specification information reception means

408 device number specification means

409 user profile registration means

410 playback information transmission means

1. A network system comprising:
a home gateway that manages a home network; and
an external server that can access the home network via an external network,
wherein the home gateway comprises:
a playback list receiving unit that downloads in advance and installs an OSGi bundle for remotely managing the home gateway from the external server, and receives playback list data which can be used for specifying a list of playback content and playback order of content, from the external server;
a playback content determination unit that determines, on the basis of the playback list data, the playback content and the playback order of the content; and
a playback instruction unit that causes a device connecting to the home network to playback the playback content in accordance with the playback order determined by the playback content determination unit, when a playback instruction for the playback content is received from the external server in accordance with the OSGi bundle.

2. The network system according to claim 1,
wherein the home gateway comprises a device information transmission unit that transmits, to the external sever, device information which can be used for specifying the device connected to the home network, and
wherein the external server comprises a playback list generation unit that generates the playback list data, wherein the playback list generation unit specifies the device connected to the home network on the basis of the device information received from the home gateway, and generates the playback list data by specifying content corresponding to the specified device.

3. The network system according to claim 1,
wherein the home gateway comprises a device information reception unit that receives, from the device connected to the home network, device specification information which can be used for satisfying the device, and a device number specification means for specifying the number of the devices connected to the home network on the basis of the received device specification information,
wherein the playback instruction unit determines the device that plays back the content in accordance with the specified result of the device number specification unit, and causes the determined device to play back the content, when receiving the playback instruction for the content from the external server.

4. The network system according to claim 1,
wherein the home gateway comprises a content reception unit that receives the content via the external network, and a content storage unit that stores the content received by the content reception unit, and
wherein the playback instruction unit instructs the device connected to the home network to play the content stored by the content storage unit.

5. The network system according to claim 1,
wherein the playback instruction unit, when receiving the playback instruction for the content, appoints a storage area of the content on the external network, and instructs the device connected to the home network to play back the content.

6. The network system according to claim 1,
wherein the home gateway comprises a user attribute registration unit that preliminarily registers user attribute information indicating a user attribute,
wherein the playback list receiving unit receives the playback list data including content attribute information indicating a content attribute, and
wherein the playback content determination unit selects, as the playback content, the content corresponding to an attribute indicated by the user attribute information among the content specified by the playback list data, on the basis of the attribute indicated by the content attribute information.

7. The network system according to claim 1,
wherein the home gateway comprises a playback information transmission unit that transmits content playback information indicating a state of a content playback.

8. The network system according to claim 1,
wherein the playback list receiving unit receives the playback list data including playback time information indicating time of the content playback, and
wherein the playback instruction unit causes the device connected to the home network to play back the content, on the basis of the coming of the time of the content playback, indicated by the playback time information.

9. A home gateway for managing a home network, comprising:
a playback list receiving unit that downloads in advance and installs an OSGi bundle for remotely managing the home gateway from an external server, and receiving playback list data which can be used for specifying a list of playback content and playback order of the content, from the external server;
a playback content determination unit that determines, on the basis of the playback list data, the playback content and the playback order of the content; and
a playback instruction unit that causes a device connecting to the home network to playback the playback content in accordance with the playback order determined by the playback content determination unit, when a playback instruction for the content is received from the external server in accordance with the OSGi bundle.

10. A content playback method comprising the steps of:
downloading in advance and installing, by a home gateway which manages a home network, an OSGi bundle for remotely managing the home gateway from an external server that can access the home network via an external network;
receiving, by the home gateway, playback list data that can be used for specifying a list of playback content and playback order of the content from the external server;
determining, by the home gateway, on the basis of the playback list data, the playback content and the playback order of the content; and
causing, by the home gateway, a device connecting to the home network to playback the playback content in accordance with the playback order determined by the home gateway, when a playback instruction for the content is received from the external server, in accordance with the OSGi bundle.

11. (canceled)
